(19) United States
(12) Patent Application Publication
(10) Pub. No.: US 2006/0114620 A1
(43) Pub. Date: Jun. 1, 2006

(54) Granular type free layer and magnetic head

(75) Inventors: Rachid Sbiaa, Tokyo (JP); Isamu Sato, Tokyo (JP); Haruyuki Morita, Tokyo (JP)

Correspondence Address: SUGHRUE MION, PLLC, 2100 PENNSYLVANIA AVENUE, N.W., SUITE 800, WASHINGTON, DC, 20037, US

(73) Assignees: TDK CORPORATION; KABUSHIKI KAISHA TOSHIBA

(21) Appl. No.: 10/998,660

(22) Filed: Nov. 30, 2004

(51) Int. Cl. G11B 5/33; G11B 5/127

(52) U.S. Cl. 360/324.12

(57) ABSTRACT

A reader of a magnetoresistive head includes a granular type free layer. The magnetoresistive head is for a current-perpendicular to plane type, and can be used in either a giant magnetoresistance (GMR) or ballistic magnetoresistance (BMR) scheme. The granular type free layer includes an insulating matrix, for example but not by way of limitation, Al₂O₃, and metal magnetic grains, for example but not by way of limitation, Ni, CoFe or NiFe. The metal grain size is about 10 to 30 nm, and the effect of having these grains interspersed in the insulative matrix is to provide a softer granular type free layer having a low magnetization. Accordingly, the granular type free layer of the present invention can be made thicker, on the order of about 5 to 10 nm, thus further improving overall thermal stability, reducing spin transfer effect and improving output read signal.

### BACKGROUND OF THE INVENTION

1. Technical Field

The present invention relates to a magnetic element (i.e., a read head) of a magnetoresistive (MR) head. More specifically, the present invention relates to a spin valve of an MR read head having a granular type free layer separated from a pinned layer by a spacer.

2. Related Art

In the related art magnetic recording technology such as hard disk drives, a head is equipped with a reader and a writer that operate independently of one another. FIGS. 1 (a) and (b) illustrate related art magnetic recording schemes. A recording medium 1 having a plurality of bits 3 and a track width 5 has a magnetization 7 parallel to the plane of the recording media. As a result, a magnetic flux is generated at the boundaries between the bits 3. This is commonly referred to as “longitudinal magnetic recording”.

Information is written to the recording medium 1 by an inductive write element 9, and data is read from the recording medium 1 by a read element 11. Coils 16 supply a write current 17 to the inductive write element 9, and a read current 15 is supplied to the read element 11. An insulating layer (not illustrated for the sake of clarity) made of Al₂O₃ is deposited between the read element 11 and the write element 9 to avoid interference between the respective read and write signals.

The read element 11 is a sensor that operates by sensing the resistance change as the sensor magnetization changes direction. A shield 13 reduces the undesirable magnetic fields coming from the media and prevents the undesired flux of adjacent bits from interfering with the one of the bits 3 that is currently being read by the read element 11.

Due to requirements of increased bit and track density readable at a higher efficiency and speed, the related art magnetic recording scheme of FIG. 1(b) has been developed. In this related art scheme, the direction of magnetization 19 of the recording medium 1 is perpendicular to the plane of the recording medium 1. This is also known as “perpendicular magnetic recording”. This design provides more compact and stable recorded data. Also, a soft underlayer (not illustrated) is required to increase the writer magnetic field efficiency. Further, an intermediate layer (not illustrated for the sake of clarity) can be used to control the exchange coupling between the recording layer 1 and soft underlayer.

FIGS. 2(a)-(c) illustrate various related art read heads for the above-described magnetic recording scheme known as “spin valves”. In the bottom type spin valve illustrated in FIG. 2(a), a free layer 21 operates as a read sensor to read the recorded data from the recording medium 1. A spacer 23 is positioned between the free layer 21 and a composed pinned layer 25. On the other side of the composed pinned layer 25, there is an anti-ferromagnetic (AFM) layer 27. In the top type spin valve illustrated in FIG. 2(b), the position of the layers is reversed.

FIG. 2(c) illustrates a related art dual type spin valve. Layers 21 through 25 are substantially the same as described above with respect to FIGS. 2(a)-(b). However, an additional spacer 29 is provided on the other side of the free layer 21, upon which a second pinned layer 31 and a second AFM layer 33 are positioned. An extra signal provided by the second pinned layer 31 increases the resistance change ΔR.

The direction of magnetization in the pinned layer 25 is substantially fixed, whereas the direction of magnetization in the free layer 21 can be changed, for example (but not by way of limitation) depending on the effect of an external magnetic field, such as the recording medium 1.

A summary of the well-known concepts of the related art read head is provided herein. When a polarized electron meets a ferromagnetic film, the electron is harmed by the magnetic moments and scattered. The lost of electron energy is transferred to the magnetic moment, based on the law of conservation of energy. This transfer of energy is manifested as torque, which acts on the ferromagnetic film. The magnetization of the free layer may be perturbed and even switch under certain conditions such as high current density, low magnetization, thin magnetic film and other intrinsic parameters, including exchange stiffness, and damping factor.

As shown in FIG. 3, if the electrons are polarized in P direction, which is assumed to be in the plane (xoy), and if it is also assumed that the free layer magnetization M is in the plane (xoy), then the spin transfer torque acts on M towards the out-of-plane direction z.

When the external magnetic field is applied to a reader, the magnetization direction of the free layer 21 is altered, or rotated, by an angle. When the flux is positive the magnetization of the free layer 21 is rotated upward, and when the flux is negative the magnetization direction of the free layer 21 is rotated downward. If the applied external field changes the free layer 21 magnetization direction to be aligned in the same way as composed pinned layer 25, then the resistance between the layers is low, and electrons can more easily migrate between those layers 21, 25.

However, when the free layer 21 has a magnetization direction opposite to that of the composed pinned layer 25, the resistance between the layers is high. This high resistance occurs because it is more difficult for electrons to migrate between the layers 21, 25. Similar to the external field, the AFM layer 27 provides an exchange coupling and keeps the magnetization of composed pinned layer 25 substantially fixed.

The resistance change ΔR when the layers 21, 25 are parallel and anti-parallel should be high to have a highly sensitive reader. The media bit is decreasing in size, and the correspondingly, the magnetic field from the media bit is weaker. As a result, it is necessary for the free layer to sense this media flux having a reduced magnitude. Therefore, it is important for the related art free layer to have a reduced thickness to maintain sufficient sensitivity of the free layer. In order to provide a high-sensitivity sensor that can sense a very weak magnetic field, this is accomplished by reducing the free layer thickness to about 3 nm in the case of an areal recording density of 150 to 200 Gbits/in².

However, as a result of the thin free layer, there is a related art problem of a stronger spin transfer effect. The spin transfer effect is substantially inversely proportional to the thickness of the film. Thus, the stability of the free layer is reduced. Further, there is also a need for a high resistance change ΔR between the layers 21, 25 of the related art read head. As discussed in greater detail below, a thicker free layer results in a higher value of ΔR.

The operation of the related art read head is now described in greater detail. In the recording media 1, flux is generated based on polarity of adjacent bits in the case of longitudinal magnetic recording. If two adjoining bits have negative polarity at their boundary, the flux will be negative. On the other hand, if both of the bits have positive polarity at the boundary, the flux will be positive. The magnitude of flux determines the angle of magnetization between the free layer and the pinned layer.

The foregoing related art read heads have various problems and disadvantages. For example, but not by way of limitation, in the above-described related art read head, when the magnetic film has a sufficiently small magnetization, the resistance of its magnetization to energy transfer momentum transfer) is weak, and its magnetization direction can thus be changed. Further, when the exchange stiffness (exchange energy between a magnetic moment and its neighbor) is small, some moments will switch before others.

FIG. 4 illustrates a related art synthetic spin valve. The free layer 21, the spacer 23 and the AFM layer 27 are substantially the same as described above. However, the composed pinned layer 25 further includes a first pinned sublayer 35 separated from a second pinned sublayer 39 by a pinned layer spacer 37. The first pinned sublayer 35 operates according to the above-described principle with respect to the composed pinned layer 25. The second pinned sublayer 39 has an opposite spin state with respect to the first pinned sublayer 35. As a result, the total composed pinned layer moment is reduced due to anti-ferromagnetic coupling between the first pinned sublayer 35 and the second pinned sublayer 39. The read head has a composed pinned layer with a total magnetic flux close to zero, and thus greater stability and high pinning field can be achieved than with the single pinned layer structure. A buffer layer 28 is deposited below the AFM layer 27 for good spin valve growth, and a cap 40 is provided on an upper surface of the free layer 21.

FIG. 5 illustrates the related art shielded read head. As noted above, it is important to avoid the sensing of unintended magnetic flux from adjacent bits during the reading of a given bit. A cap (protective) layer 40 is provided on an upper surface of the free layer 21 to protect the spin valve against oxidation before deposition of top shield 43, by electroplating in a separated system. Similarly, a bottom shield 45 is provided on a lower surface of the buffer layer 28.

Related art magnetic recording schemes use a current perpendicular to plane (CPP) head, where the sensing current flows perpendicular to the spin valve plane. As a result, the size of the read head can be reduced without loss of the output read signal. Various related art spin valves that operate in the CPP scheme are illustrated in FIGS. 6(a)-(c), and are discussed in greater detail below. These spin valves structurally differ primarily in the composition of their spacer 23. The compositions and resulting difference in operation of these effects is discussed in greater detail below.

FIG. 6(a) illustrates a related art tunneling magnetoresistive (TMR) head for the CPP scheme. In the TMR head, the spacer 23 acts as an insulator, or tunnel barrier layer. Thus, in the case of a very thin barrier that is the spacer 23 the electrons can migrate from free layer 21 to pinned layer 25 or vice versa without change of spin direction. Current related art TMR heads have an increased magnetoresistance (MR) on the order of about 30-50%.

FIG. 6(b) illustrates a related art CPP-GMR head. In this case, the spacer 23 acts as a conductor. In the related art CPP-GMR head, there is a need for a large resistance change ΔR, and a moderate element resistance for having a high frequency response. A low free layer coercivity is also required so that a small media field can be detected. The pinning field should also have a high strength. Additional details of the CPP-GMR head are discussed in greater detail below.

FIG. 6(c) illustrates the related art ballistic magnetoresistance (BMR) head. In the spacer 23, which operates as an insulator, a ferromagnetic region 47 connects the pinned layer 25 to the free layer 21. The area of contact is on the order of a few nanometers. This is referred to as a nano-path or a nano-contact. As a result, there is a substantially high MR, due to electrons scattering at the domain wall created within this nano-contact. Other factors include the spin polarization of the ferromagnets, and the structure of the domain that is in nano-contact with the BMR head.

In the foregoing related art heads, the spacer 23 of the spin valve is an insulator for TMR, a conductor for GMR, and an insulator having a magnetic nano-contact for BMR. While related art TMR spacers are generally made of insulating materials such as alumina, related art GMR spacers are generally made of conductive metals, such as copper.

In the related art GMR head, resistance is minimized when the magnetization directions (or spin states) of the free layer 21 and the pinned layer 25 are parallel and is maximized when the magnetization directions are opposite. As noted above, the free layer 21 has a magnetization of which the direction can be changed. Thus, the GMR system avoids perturbation of the head output signal by minimizing the undesired switching of the pinned layer magnetization.

GMR depends on the degree of spin polarization of the pinned and free layers, and the angle between their respective magnetizations. Spin polarization depends on the difference between the spin state (up or down) in each of the free and pinned layers. As the free layer 21 receives the flux from the magnetic recording media, the free layer magnetization rotates by a small angle in one direction or the other, depending on the direction of flux. The change in resistance between the pinned layer 25 and the free layer 21 is proportional to angle between the moments of the free layer 21 and the pinned layer 25, as noted above. There is a relationship between resistance change and the reader output signal.

The GMR head has various requirements. For example, but not by way of limitation, a large resistance change ΔR is required to generate a high output signal. In order to generate the large resistance change ΔR, it is desirable to have thicker free layer. This relationship is shown in FIG. 7(a). A similar relationship exists between the MR ratio and free layer thickness, as shown in FIG. 7(b). Therefore, the thinner free layer, which is required to sense a smaller media bit with a weaker signal, also has a lower MR and AΔR in the related art CPP scheme. As a result, the related art spin transfer effect problem is increased.

While not shown in the foregoing figures, a similar relationship exists for the pinned layer thickness. For synthetic spin valve heads, the thickness of the sublayer of the pinned layer closest to the spacer 23 has the above-described relationship.

A free layer with low coercivity is also desired, so that small media fields can also be detected. With high pinning field strength, the antiferromagnetic structure between the free and pinned layer is well defined. When the interlayer coupling between the pinned layer and free layer is low the sensing layer is not adversely affected by the pinned layer. Further, low magnetostriction is desired to minimize stress on the free layer.

In the related art studies, for example, from the data of S. Hope et al., Physical Review B 55, 11422 (1997), a decrease in magnetic film thickness can result in a decrease in magnetization. Such a decrease of film thickness can reduce ΔR and maximize the perturbation due to the spin transfer effect.

As recording media bit size is reduced, a thinner free layer is also needed. In the future, it is believed that the need to reduce free layer thickness will continue. There is also a need to sense increasingly smaller bits at a very high frequency (i.e., high data rate) in magnetic recording technology.

In the related art head described above, there are various problems and disadvantages. For example, but not by way of limitation, there is a related art problem of thermal instability that results from the high demagnetization field. Additionally, a high spin transfer effect results from the decreased thickness of the free layer, and the corresponding low magnetization to produce a high sensitivity to the media field. The more pronounced spin transfer effect reduces stability. Accordingly, there is an unmet need for a free layer that is sensitive enough to read the smaller media bit, but is also stable and does not suffer the aforementioned problems and disadvantages of the related art, such as the spin transfer effect.

### SUMMARY OF THE INVENTION

It is an object of the present invention to overcome the related art problems and disadvantages. However, such an object, or any object, need not be achieved in the present invention.

Accordingly, a magnetic element is provided for reading a recording medium, and includes a spin valve. The magnetic element further includes a granular type free layer having a magnetization adjustable in response to an external field, the granular type free layer comprising a non-magnetic insulating matrix and magnetic grains that comprise a magnetic material disposed therein; a pinned layer having a substantially fixed magnetization; and a spacer sandwiched between the pinned layer and the granular type free layer. The foregoing may also be implemented in a device.

### BRIEF DESCRIPTION OF THE DRAWINGS

FIGS. 1(a) and (b) illustrates a related art magnetic recording scheme having in-plane and perpendicular-to-plane magnetization, respectively;

FIGS. 2(a)-(c) illustrate related art bottom, top and dual type spin valves;

FIG. 3 illustrates the related art spin transfer effect;

FIG. 4 illustrates a related art synthetic spin valve for a magnetoresistive reader head;

FIG. 5 illustrates a related art read head having a shielded structure;

FIGS. 6(a)-(c) illustrates various related art magnetic element systems;

FIGS. 7(a)-(b) illustrate the dependence of AΔR and MR, respectively, on free layer thickness in the CPP scheme;

FIG. 8 illustrates a CPP-GMR type magnetoresistive head according to a first exemplary, non-limiting embodiment of the present invention;

FIG. 9 illustrates a CPP-BMR type magnetoresistive head according to a second exemplary, non-limiting embodiment of the present invention;

FIG. 10 is a schematic top view of the free layer according to an exemplary, non-limiting embodiment of the present invention;

FIG. 11 illustrates the read head according to an exemplary, non-limiting embodiment of the present invention;

FIG. 12 illustrates the read head according to another exemplary, non-limiting embodiment of the present invention;

FIGS. 13(a)-(b) illustrate additional free layer configurations according to exemplary, non-limiting embodiments of the present invention;

FIG. 14 illustrates an alternative pinning scheme according to an exemplary, non-limiting embodiment of the present invention; and

FIGS. 15(a)-(b) illustrate the relationship between normalized magnetization and applied magnetic field for various exemplary, non-limiting embodiments of the present invention.

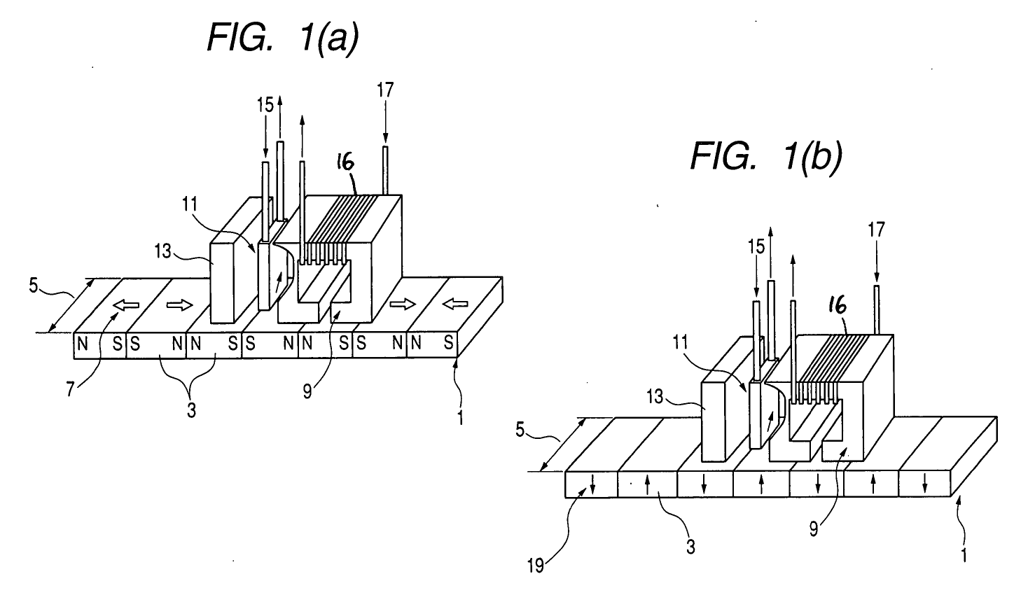

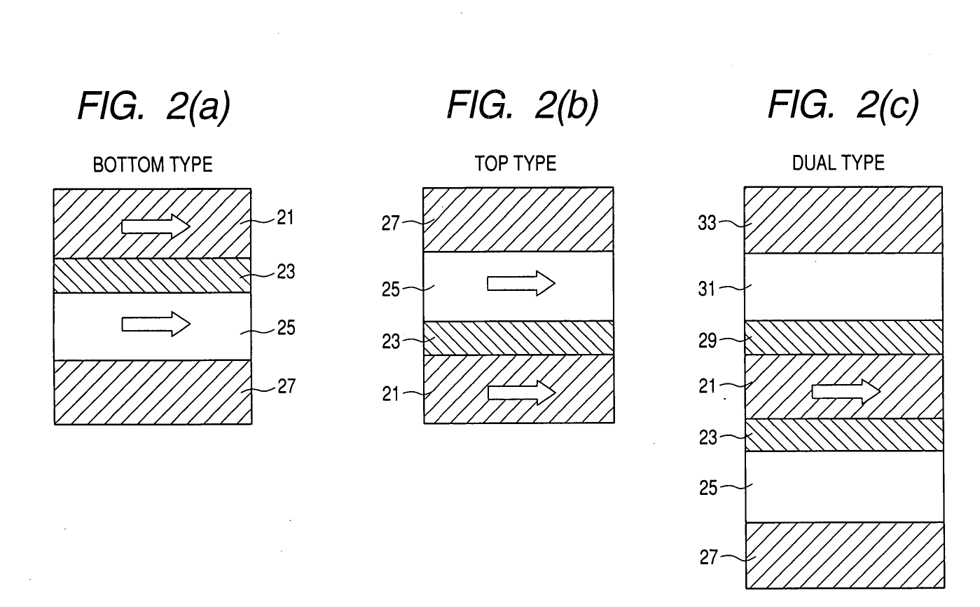

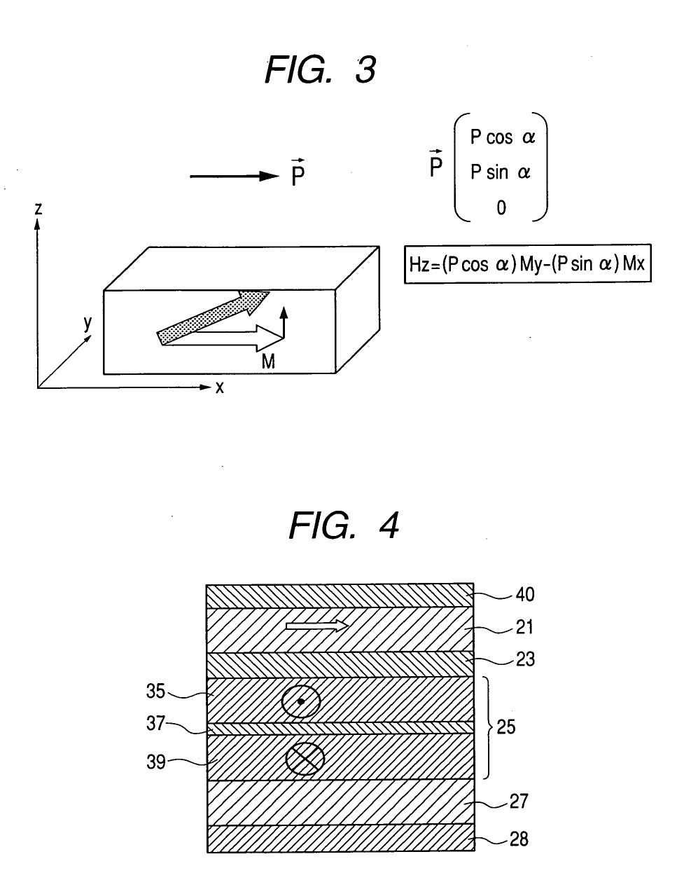

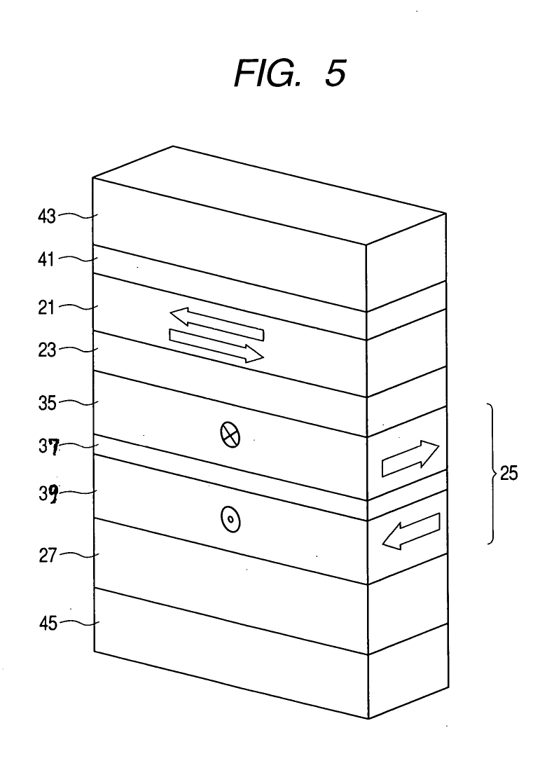

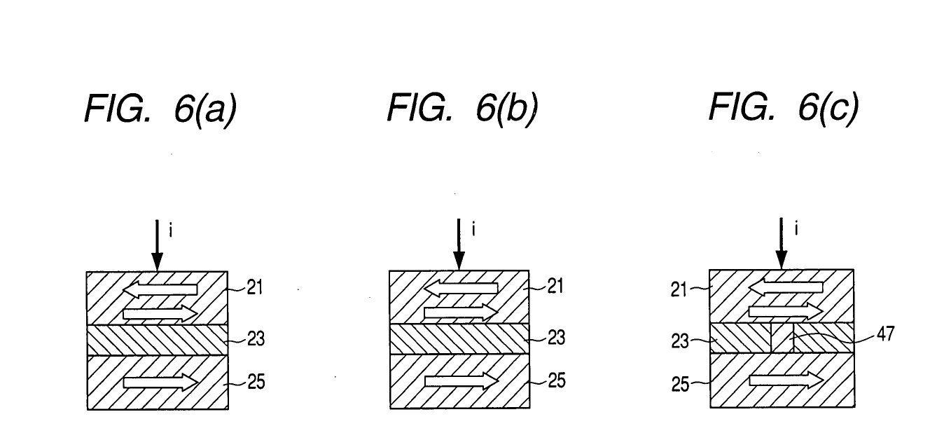

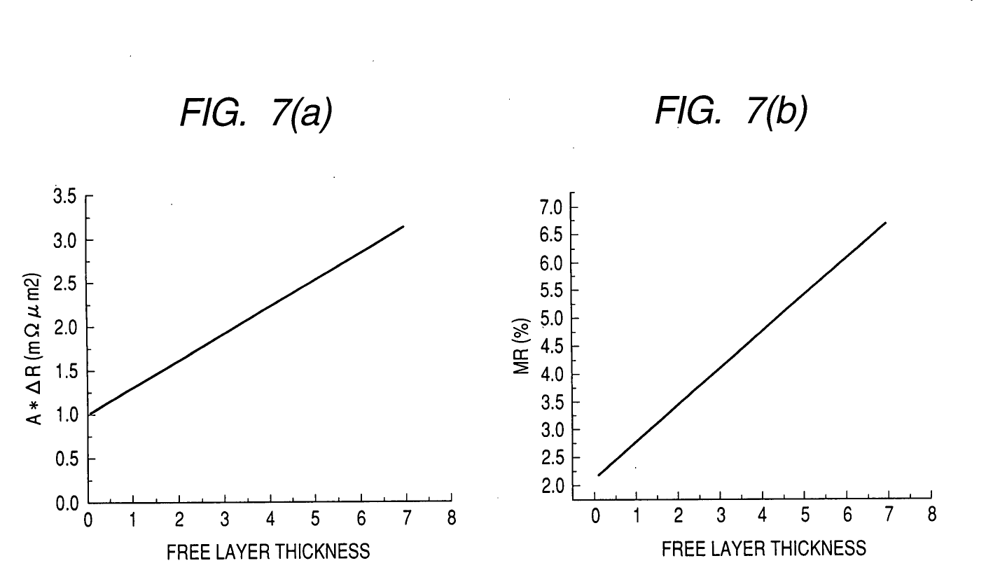

### DETAILED DESCRIPTION OF THE INVENTION

The present invention includes a read head having a low magnetization and low anisotropy material, as well as a large thickness made possible by the novel granular type free layer according to the exemplary, non-limiting embodiments described herein, and equivalents thereof as would be known by one of ordinary skill in the art. Granular type is defined to include a non-magnetic matrix and magnetic grains embedded therein.

In the present invention, the term “read head” is used interchangeably with the term “magnetic sensor”, and refers to the overall apparatus for sensing data from a recording media. In this regard, “magnetic sensor” is one particular type of “magnetic element”, and where magnetic sensors are used in the specification, other magnetic elements (e.g., random access memory or the like) may be substituted therein, as would be known by one of ordinary skill in the art.

Additionally, the term “magnetic element” is defined to include “magnetoresistance effect element” and/or “magnetoresistance element” as is understand by those of ordinary skill in this technical field. However, the present invention is not limited thereto, and other definitions as would be understood by those of ordinary skill in the art may be substituted therefore without narrowing the scope of the invention. Further, the term “spin valve” is used to refer to the specific structural makeup of the read head layers.

By using a ferromagnetic thin film of a granular type such as Ni—Al₂O₃ or CoFe—Al₂O₃ (a matrix is made of Al₂O₃ and grains are made of Ni or CoFe, or an equivalent thereof) for the free layer, the magnetization is reduced by about 4-fold with respect to the related art continuous free layer of the substantially same thickness. Therefore, the granular type free layer thickness can be increased to improve stability by reducing the related art spin transfer effect. Further, when the percentage of metal grains in the film is increased (e.g., from 20 to 30 percent), an improved performance is observed.

In the present invention, the result of the granular type free layer is improved softness, low magnetization and good crystal growth. Thus, a thicker free layer having an improved sensitivity to smaller media bit size can be obtained. Accordingly, the related art benefits of having a thicker free layer can be obtained without the related art problems and disadvantages of such a thicker continuous free layer. The stability of the free layer and the head generally is thus improved.

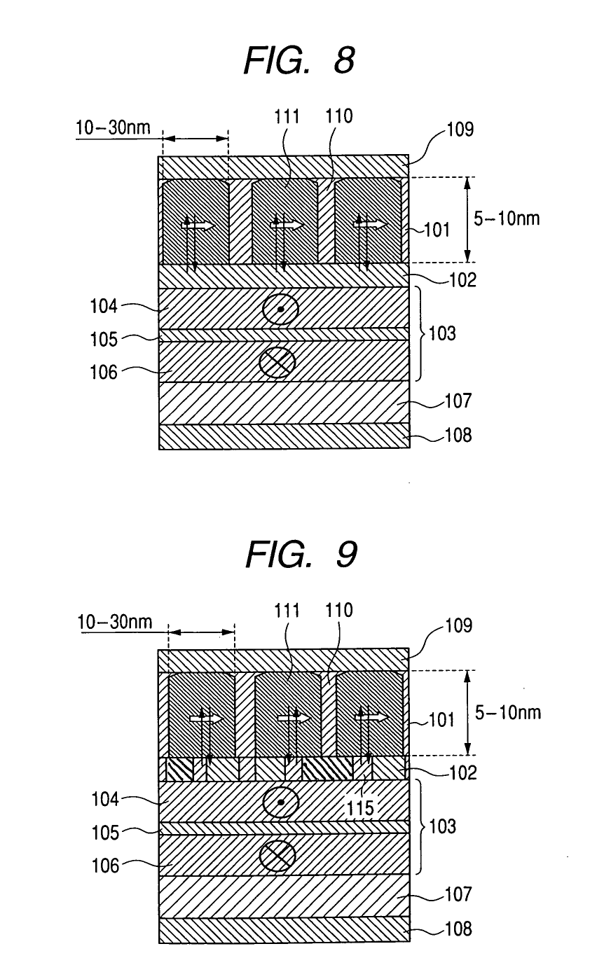

FIGS. 8 and 9 illustrate first and second exemplary, non-limiting embodiments of the present invention. FIG. 8 is directed to a magnetic head of the current-perpendicular-to-plane, giant magnetoresistance (CPP-GMR) type, while FIG. 9 is directed to the CPP, ballistic magnetoresistance (CPP-BMR) type magnetic head. Both of these embodiments include a granular type free layer 101 separated by a spacer 102 from a pinned layer (i.e., a composed pinned layer) 103 having a first pinned sublayer 104, a pinned layer spacer 105 and a second pinned sublayer 106. The free layer 101 has an adjustable magnetization direction in response to an external field generated from a medium like a hard disk, and the pinned layer 103 has a substantially (i.e., except for external magnetization effects, such as “noise” from the device in which the present invention is applied) fixed magnetization direction.

The first pinned sublayer 104 is in contact with the spacer 102 and separated from the second pinned sublayer 106 by the pinned layer spacer 105. The first pinned sublayer 104 has a magnetization direction opposite to that of the second pinned sublayer 106. A pinned layer consisting of a single layer (not illustrated) can be used instead of the composed pinned layer 103.

An antiferromagnetic (AFM) layer 107 is grown on a buffer 108. The AFM layer 107 is positioned adjacent to the second pinned sublayer 106, and the buffer 108 is positioned adjacent to the AFM layer 107. The AFM layer 107 is made of at least one of PtMn, IrMn, PtPdMn and FeMn, or an equivalent thereof as would be known by one of ordinary skill in the art. The buffer 108 is made of NiCr, NiFeCr and a (Ta/NiFe) bilayer. On an upper surface of the granular type free layer 101, a cap layer 109 is provided.

The CPP-GMR and CPP-BMR heads structurally differ from each other in terms of their spacer 102. While the spacer 102 of the CPP-GMR head is conductive, the spacer 102 of the CPP-BMR head shown in FIG. 9 is insulative except along a nano-path 115 for current flow.

More specifically, the spacer 102 can be made of a conductive material (e.g., Cu, Ag, Cr, or equivalent material as would be known by one of ordinary skill in the art) in the case of CPP-GMR. An insulating material (e.g., Al₂O₃, SiO₂, SiN₃ or equivalent material as would be known by one of ordinary skill in the art) is provided in the case of CPP-BMR as an insulative matrix. Where the insulative matrix is provided, the spacer 102 can include the nano-path 115 comprising a magnetic conductive material embedded in the insulative matrix to form the current confined path. In another type of CPP the spacer 102 can include a non-magnetic conductive material embedded in the insulative matrix to form the current coined path head. A plurality of a magnetic and a non-magnetic conductive nano-contact is may be used, but one or the other type of nano-contact 115 is preferred.

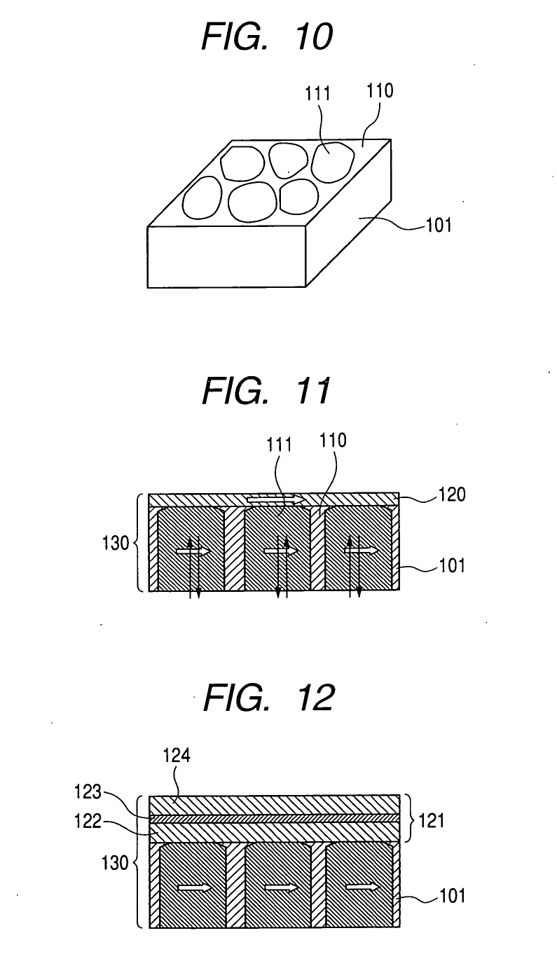

FIG. 10 is a schematic view of the granular type free layer 101. In the granular type free layer 101, an insulator 110 (or insulating matrix), preferably non-magnetic, is interspersed between magnetic grains 111. For example, but not by way of limitation, the insulator 110 can be Al₂O₃, SiO₂, Si₃N₄ or AlN and the magnetic grains 111 comprise one of Ni, Co, and Fe, preferably NiFe, CoFe, CoNi or CoFeNi. Preferably, the magnetic grains 111 have an average diameter of about 10 to 30 nm. Preferably, the thickness of the granular type free layer 101 is about 5-10 nm, as compared with the maximum related art continuous free layer thickness of 3 nm. At least one of the grains reaches both surfaces of the granular type free layer. The granular type free layer 101 can have this greater thickness due to the decreased magnetization, as measured by a VSM (vibrating sample magnetometer).

Additional continuous sublayers can also be included with the granular type free layer 101, so as to increase the free layer remanence magnetization (i.e., the magnetic induction that remains in a material after removal of the magnetic field) while keeping its saturation magnetization and coercivity substantially small. These embodiments are discussed in greater detail below and illustrated in FIGS. 11-13.

The pinned sublayer 104 (and optionally, the pinned sublayer 106), and the grains 111 and nano-contact 115 include at least one of Co, Fe and Ni, so that the pinned sublayer 104, the grains 111 and the nano-contact 115 can be made of the same material, but the present invention is not limited thereto. The pinned sublayer 104 and the granular type free layer 101 can either be single layers or synthetic layers that include a stack of ferromagnetic layers. Alternatively, two sublayers may be coupled antiferromagnetically to each other.

FIG. 11 illustrates another exemplary, non-limiting embodiment of the free layer of the present invention, and can be incorporated into either of the CPP-GMR or CPP-BMR structures illustrated in FIGS. 8 and 9, respectively, and described above. Discussion and illustration of the already-discussed reference characters is omitted for the sake of brevity. The embodiment of FIG. 11 includes a composed free layer 130, in which a free sublayer 120 is added above the granular type free layer 101 to improve the ferromagnetism of the granular type free layer 101. Because magnetic grain size may vary and sometimes magnetic grains are too small and cannot be sufficiently ferromagnetic, the free sublayer 120 helps, by exchange coupling, to make the granular type free layer 101 ferromagnetic.

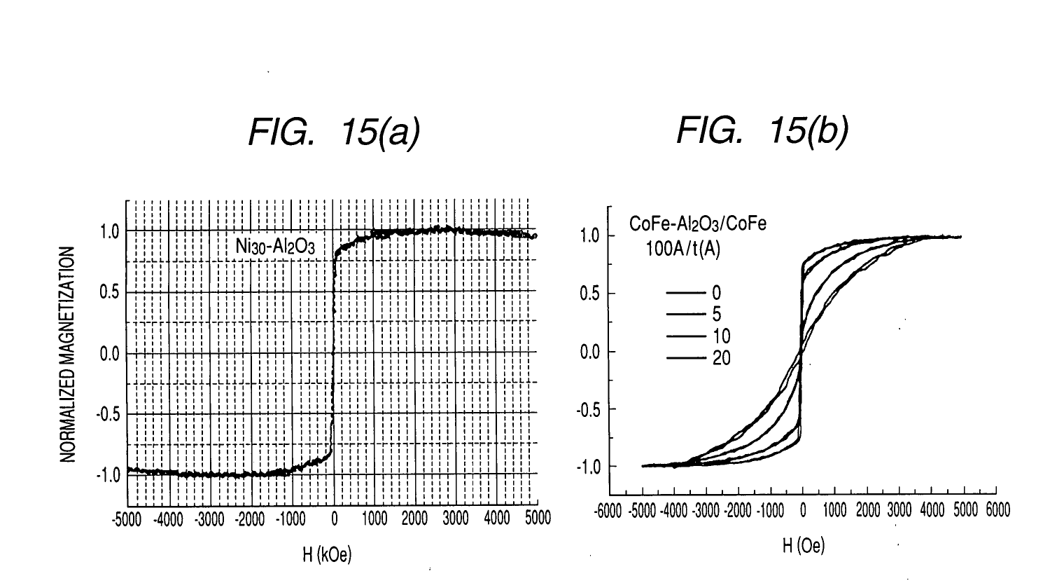

As shown in FIG. 15(b), only 20% thick continuous CoFe can substantially improve the remanence magnetization of the super-paramagnetic grains. This embodiment corresponds to 20 Ã CoFe and 100 Ã CoFe—Al₂O₃. For example, but not by way of limitation, if the conductive magnetic grains size is small and/or the percentage of Ni is reduced (e.g., Ni at 20% instead of 30%), the first free sublayer 120 improves the ferromagnetic properties of the granular type free layer 101, and thus increases stability.

FIG. 12 illustrates yet another exemplary, non limiting embodiment of the present invention. Discussion and illustration of the already-discussed reference characters is omitted for the sake of brevity. In this exemplary embodiment, the composed free layer 130 includes the granular type free layer 101 discussed above, and a free sublayer 121 that is synthetic and includes a first continuous ferromagnetic sublayer 122 above the granular type free layer 101, a free sublayer spacer 123 above the first continuous ferromagnetic sublayer 122, and a second continuous ferromagnetic sublayer 124 above the free sublayer spacer 123. The second continuous ferromagnetic-sublayer 124 has an opposite direction of magnetization from the first continuous ferromagnetic sublayer 122.

The first continuous ferromagnetic sublayer 122 and the second continuous ferromagnetic sublayer 124 are made of a composition such as Ni, Co, NiFe, CoFeNi, CoFe or equivalent thereof, and the free sublayer spacer 123 is made of Ru, Rh, Ag or an equivalent thereof. As a result of the foregoing synthetic free sublayer 121, the granular part in the free layer 130 is in a ferromagnetic state with high remanence magnetization. Further, the total magnetization of the whole free layer 130 is substantially small, thus leading to a high sensitivity and thermal stability.

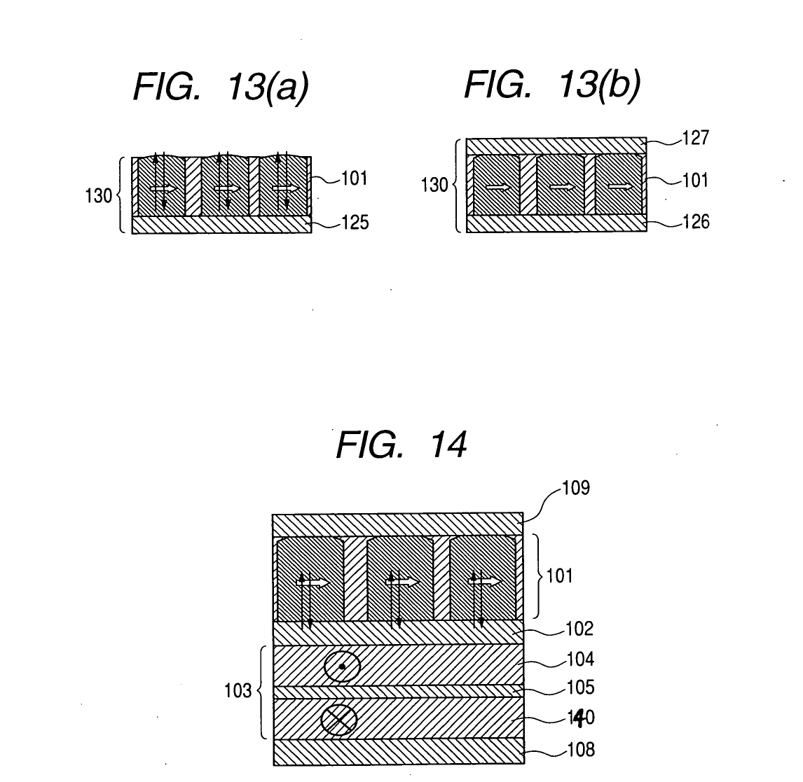

FIGS. 13(a)-(b) illustrate additional exemplary, non-limiting configurations of the composed free layer 130, including the granular type free layer 101 and various free sublayers. As shown in FIG. 13(a), a free sublayer 125 is added on the bottom of the granular type free layer 101. In FIG. 13(b), a first free sublayer 126 is added on the bottom of the granular type free layer 101, and a second free sublayer 127 is added on top of the granular type free layer 101. Optionally, the free sublayer 125 in FIG. 13(a) and the first and second free sublayers 126 and 127 in FIG. 13(b) can contact the grains 111 in the sub-free layer 101, but the present invention is not limited thereto.

Similar to above, while the embodiments illustrated in FIGS. 13(a)-(b) are CPP-BMR heads, the CPP-GMR head illustrated in FIG. 8 could be substituted for the CPP-BMR head, with the embodiment having a substantially similar impact (e.g., further domain stabilization) on head performance.

In addition to the foregoing exemplary, non-limiting embodiments of the free layer, FIG. 14 illustrates an exemplary, non-limiting embodiment of the present invention that includes a modified composed pinned layer 103. The first pinned sublayer 104 in contact with the spacer 102, and a pinned layer spacer 105, preferably made of Rh and/or Ru, below the first pinned sublayer 104, are substantially the same as for the above-disclosed exemplary, non-limiting embodiments. The discussion of these and other already-disclosed features are omitted for the sake of brevity. However, the present exemplary, non-limiting embodiment differs from above-described embodiments in that below the pinned layer spacer 105, a hard magnet 140 is provided instead of the above-described second pinned sublayer 106 and the AFM layer 107. Thus, the first pinned sublayer 104 is the only pinned sublayer ni this embodiment. The hard magnet 140 is made of a material comprising at least one of CoSm, XPt, XPtCr and XPtCrB, where X═Fe, Co or FeCo, preferably CoPt, FePt and CoCrPt, or equivalent thereof as would be known by one of ordinary skill in the art. The buffer 108 is provided below the hard magnet 140.

As a result of this modification, the magnetization direction of the hard magnet 140, with high coercivity, does not substantially change under the media magnetic field. Further, because of the strong antiferromagnetic coupling between the hard magnet 140 and the first pinned sublayer 104, the pinned layer 103 will have its magnetization direction substantially fixed and its total magnetization reduced. As a result, the overall pinned layer stability is substantially improved. This embodiment is known as a “self-pinned” scheme, and can be used with any of the foregoing exemplary, non-limiting embodiments of the present invention described above and described in FIGS. 8-14.

FIGS. 15(a)-(b) illustrate the magnetic properties of the free layer according to the present invention. In FIG. 15(a), the magnetization as a function of magnetic field is shown for a granular type free layer having a composition of Ni—Al₂O₃. The magnetic grains size in this embodiment is about 16 nm. The result is a granular type free layer having a ferromagnetic character with a low coercivity (about 10 Oe) and a low saturation magnetization (less than about 1.5 kG). In the present invention it is noted that the Al₂O₃ insulating layer can be replaced with an equivalent insulating layer, as would be known by one of ordinary skill in the art. Further, instead of using an electrically insulating layer, conductive materials may be used instead. Also, instead of using Ni as the metal for the magnetic grains 111, other metals such as Co, CoFe, NiFe, CoFeNi and the like may be used. Preferably, the granular type free layer has a coercivity of not more than about 20 Oe and a saturation magnetization not more than about 2.0 kG.

FIG. 15(b) illustrates the relationship between external magnetic field and magnetization for various composed free layers. The granular part free layer 101 has a substantially fixed thickness of 100 Ã, while the continuous sub-free layer has various Thicknesses, as illustrated in FIG. 11. In the case of a granular type free layer 101 without any back up layer positioned thereon, there is no magnetic remanence state.

As the thickness of the continuous free layer 120 above the granular type free layer 101 increases, the remanence magnetization of the whole free layer 130 increases correspondingly. By exchange coupling between the low moment magnetic grains and the thin continuous ferromagnetic layer, the magnetic grains themselves become ferromagnetic, as shown in FIG. 15(b).

In the present invention, the free layer (granular and/or composed of granular and continuous film) may be stabilized using a hard bias on the side of the read head. Alternatively, an in-stack bias may be applied as a ferromagnetic layer deposited on top of the free layer (granular and/or composed) and separated therefrom by a non-magnetic exchange decoupling spacer. While the bias configurations are not shown in the foregoing figures, these structures are well-known in the related art, and it is believed that one of ordinary skill in the art would be able to incorporate the above-described bias into the present invention.

Additionally, the granular type free layer 101 of the present invention be used in a top type spin valve where the free layer is deposited before the pinned layer, a bottom type spin valve where the pinned layer is deposited before the free layer, or a dual type spin valve, where the free layer is located between two pinned layers.

While the present invention is directed to the granular type free layer 101 and its variants including a synthetic free layer 121, the present invention is not limited thereto. For example, but not by way of limitation, the granular film may be used in other layers where similar properties are desired.

The present invention has various advantages. For example, but not by way of limitation, the granular type free layer of the head according to the present invention has an increased softness and corresponding lower magnetostriction. Further, low magnetization and good crystal growth occur in the present invention. As a result, the granular type free layer of the present invention can be substantially thicker. A synthetic free layer may also be formed to enhance performance by adding various continuous layers as described above.

The granular type free layer can be made by plasma sputtering or ion beam deposition method, or equivalent method as would be known by one of ordinary skill in the art.

Additionally, the foregoing embodiments are generally directed to a magnetoresistive element for a magnetoresistive read head. This magnetoresistive read head can optionally be used in any of a number of devices. For example, but not by way of limitation, as discussed above, the read head can be included in a hard disk drive (HDD) magnetic recording device. However, the present invention is not limited thereto, and other devices that uses the ballistic magnetoresistive effect may also comprise the magnetoresistive element of the present invention. For example, but not by way of limitation, a magnetic random access memory (i.e., a magnetic memory device provided with a nano-contact structure) may also employ the present invention. Such applications of the present invention are within the scope of the present invention.

The present invention is not limited to the specific above-described embodiments. It is contemplated that numerous modifications may be made to the present invention without departing from the spirit and scope of the invention as defined in the following claims.

We claim:

1. A magnetic element comprising:
a granular type free layer having a magnetization direction adjustable in response to an external field, said granular type free layer comprising a non-magnetic insulating matrix and magnetic grains that comprise a magnetic material disposed therein;
a pinned layer having a substantially fixed magnetization direction; and
a spacer sandwiched between said pinned layer and said granular type free layer.

2. The magnetic element of claim 1, wherein said magnetic grains have a cross section diameter of between about 10 nm and 30 nm.

3. The magnetic element of claim 1, wherein said granular type free layer has a thickness between about 5 nm and 10 nm.

4. The magnetic element of claim 1, wherein said pinned layer is a composed pinned layer having a first pinned sublayer in contact with said spacer and separated from a second pinned sublayer by a pinned layer spacer, said first pinned sublayer having a magnetization direction opposite to said second pinned sublayer.

5. The magnetic element of claim 1, farther comprising:
an antiferromagnetic (AFM) layer positioned adjacent to said pinned layer;
a buffer positioned adjacent to said AM layer; and
a cap positioned adjacent to said granular type free layer.

6. The magnetic element of claim 5, wherein said AFM layer comprises at least one of PtMn, IrMn, PtPcMn and FeMn.

7. The magnetic element of claim 1, wherein said spacer comprises one of (a) a conductive material and, (b) an insulating matrix with one of (i) at least one nano-path and (ii) at least one conductive material.

8. The magnetic element of claim 7, wherein said conductive material comprises one of Cu, Ag, and Cr.

9. The magnetic element of claim 7, wherein said insulating a matrix comprises at least one of an Al₂O₃, SiO₂ and Si₃N₄, and said nano-contact comprises at least one of Ni, Co, CoFe, and CoFeNi.

10. The magnetic element of claim 1, wherein said pinned layer comprises at least one of Co, Fe and Ni, and said magnetic grains comprise at least another of Co, Fe and Ni that is not present in said pinned layer.

11. The magnetic element of claim 1, said granular type free layer further comprising a free sublayer positioned adjacent to at least one of an upper surface and a lower surface of said granular type free layer.

12. The magnetic element of claim 11, wherein said free sublayer comprises a ferromagnetic material.

13. The magnetic element of claim 11, wherein said sub-free layer comprises a first continuous ferromagnetic sublayer above the granular type free layer, a free sublayer spacer above the first continuous ferromagnetic sublayer, and a second continuous ferromagnetic sublayer having an opposite direction of magnetization from the first continuous ferromagnetic sublayer, said second continuous ferromagnetic sublayer being positioned above the free sublayer spacer.

14. The magnetic element of claim 13, wherein the first continuous ferromagnetic free sublayer and the second continuous ferromagnetic free sublayer comprise one of Ni, Co, NiFe, CoFeNi and CoFe.

15. The magnetic element of claim 1, wherein said pinned layer comprises a pinned sublayer in contact with said spacer, a pinned layer spacer positioned opposite said spacer, and a hard magnet on a side of said pinned layer spacer opposite said pinned sublayer.

16. The magnetic element of claim 15, wherein said hard magnet comprises at least one of CoPt and CoCrPt.

17. The magnetic element of claim 1, wherein the granular type free layer has a coercivity of not more than about 20 Oe and a saturation magnetization not more than about 2.0 kG.

18. The magnetic element of claim 1, further comprising at least one of: (a) a hard bias on at least one side of the magnetic element; and (b) an in stack bias applied as a ferromagnetic layer above the granular type free layer, and separated from the granular type free layer by a non-magnetic exchange decoupling spacer.

19. The magnetic element of claim 1, wherein said magnetic element is one of a bottom type spin valve, a top type spin valve, and a dual type spin valve.

20. The magnetic element of claim 1, wherein said granular type free layer is made by one of plasma sputtering and ion beam deposition.

21. A device, comprising:
a granular type free layer having a magnetization direction adjustable in response to an external field, said granular type free layer comprising a non-magnetic insulating matrix and magnetic grains that comprise a magnetic material disposed therein;
a pinned layer having a substantially fixed magnetization direction; and
a spacer sandwiched between said pinned layer and said granular type free layer.
